(19) United States
(12) Patent Application Publication
(10) Pub. No.: US 2006/0264256 A1
(43) Pub. Date: Nov. 23, 2006

(54) GAMING SYSTEM WITH ADMINISTRATIVE INTERFACES FOR MANAGING DOWNLOADABLE GAME COMPONENTS

(76) Inventors: Mark B. Gagner, West Chicago, IL (US); Craig J. Sylla, Round Lake, IL (US); Vernon W. Hamlin, Lisle, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/279,489

(22) Filed: Apr. 12, 2006

Related U.S. Application Data
(60) Provisional application No. 60/670,485, filed on Apr. 12, 2005.

(51) Int. Cl. A63F 13/00; A63F 9/24

(52) U.S. Cl. 463/20; 463/42

(57) ABSTRACT

Systems and methods provide a user interface to control the download of gaming configuration elements to one or more wagering game machines. The gaming configuration elements may include banner content, advertising content, denomination data, pay table, language data, video content, audio content, episodic game data, wagering game software, operating system software, device driver software and device firmware.

### RELATED APPLICATION

This application claims priority under 35 U.S.C. 119(e) from U.S. Provisional Application Serial No. 60/670,485 filed Apr. 12, 2005, which application is incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, WMS Gaming, Inc.

### BACKGROUND

Wagering game machines may be operated as a stand alone unit, or linked in a network of some type to a group of wagering game machines. As technology in the gaming industry progresses, more and more gaming services are being provided to wagering game machines via communication networks that link groups of wagering game machines to a remote central server computer that provides one or more gaming services. As an example, gaming services that may be provided by the remote computer to a wagering game machine via a communication network of some type include player tracking, accounting, cashless award ticketing, lottery, progressive games and bonus games. In addition, wagering game machines are evolving into gaming platforms where the gaming services and game play options provided on the wagering game machines may be dynamically configured. Thus, the number and type of game services and game play options offered on a particular wagering game machine may vary with time.

A gaming entity may operate hundreds, thousands or ten of thousands of wagering game machines. Since gaming is allowed in many locations throughout the world, casinos may have games distributed over a wide geographic area. Within casinos, the wagering game machines may be connected via one or more dedicated networks. Servers are usually located in a backroom of the casino away from the casino floor.

Current techniques for initially loading, modifying or replacing game software in wagering game machines are generally inconvenient, time-consuming, and expensive. In one technique, the entire wagering game machine is disconnected from the central server and replaced with a new machine. This involves the shipment of machines to and from a gaming establishment and requires the services of an appreciable number of skilled and semi-skilled service personnel. The service personnel must identify the machines to be replaced, locate the machines on the gaming establishment floor, and then replace the existing machines with the new machines. In another technique, the media containing the software is replaced with new media containing the new software. Again, the service personnel must identify the machines to receive the new software media, locate the machines on the gaming establishment floor, and then replace the existing media with the new media. In this case, media may be a hard disk, flash, various non-volatile media such as EEPROM, EPROM, etc.

In yet another technique, the new software can be downloaded to the wagering game machine from the central server linked to the wagering game machine. This downloading technique facilitates modifications to the game software in that it does not require removal of the wagering game machine and does not require service personnel to visit the wagering game machine site or the wagering game machine itself. However, managing wagering game machines that can receive downloaded software and data can be a problem. Determining which software and data belongs on which wagering game machine can be a daunting task, especially in a gaming establishment with numerous wagering game machines, or in environments where numerous wagering game machines exist across multiple gaming establishments. The complexity of the problem and the number of potential configurations increases rapidly with the number of wagering game machines that can receive downloadable software and data.

### SUMMARY

The above-mentioned shortcomings, disadvantages and problems are addressed by the present invention, which will be understood by reading and studying the following specification.

Systems and methods provide administrative user interfaces for configuring and controlling wagering game machines in a gaming network. One aspect of the systems and methods includes a user interface that is operable to provide graphical objects that represent gaming configuration elements. A user may drag the graphical objects onto other graphical object in order to update configurations or to initiate downloads to a wagering game machine.

A further aspect of the systems and methods includes the ability for a user to be prompted to enter parameters to update a wagering game machine configuration. The system may limit parameter input to a set of valid values.

A still further aspect of the systems and methods includes providing a schedule that may be used to determine when gaming configuration elements may be downloaded to one or more wagering game machines.

The wagering game machine configuration elements may include banner content, advertising content, denomination data, pay table, language data, video content, audio content, episodic game data, wagering game software, operating system software, device driver software and device firmware.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a perspective view of a wagering game machine according to an example embodiment.

FIG. 2 is a block diagram of processing components of a wagering game machine according to an example embodiment.

FIG. 3 is a block diagram of major software components of a wagering game machine according to an example embodiment.

FIG. 4 is a block diagram of a network of wagering game machines and administration computers according to an example embodiment.

FIGS. 5A-5C are flowcharts illustrating methods of providing configuration elements to a machine in the network of FIG. 4.

FIG. 6 is a diagram illustrating a graphical user interface method according to an example embodiment for configuring one or more wagering game machines in a network.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

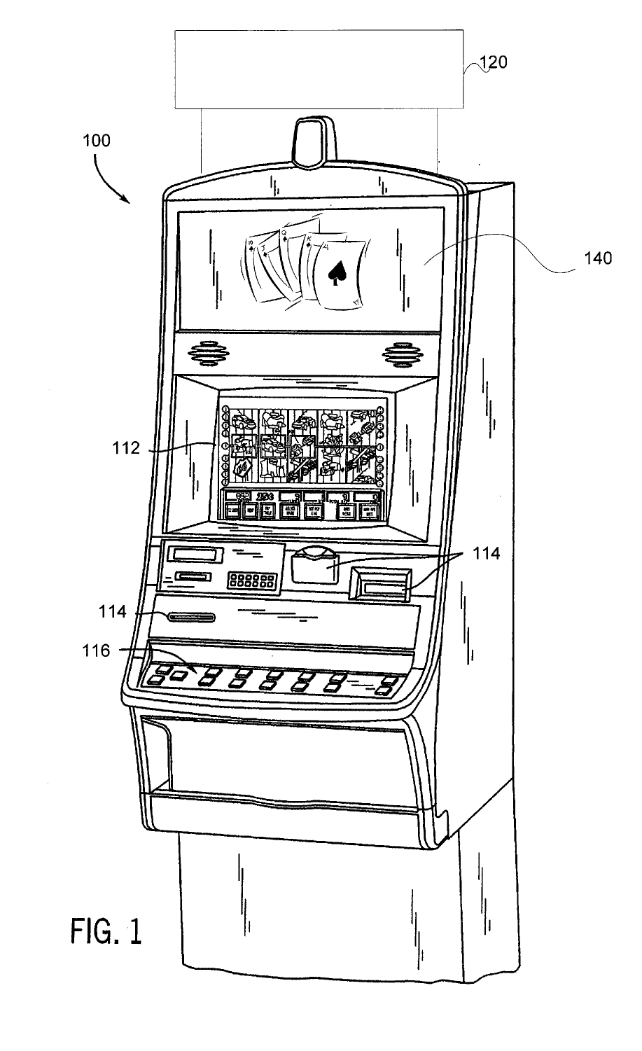

FIG. 1 illustrates an example wagering game machine 100 in which may be included various embodiments of the invention. In some embodiments, wagering game machine 100 is operable to conduct a wagering game. These wagering games may include reel based wagering games such as mechanical or video slots, card based games such as video poker, or other types of wagering games such as video keno, video bingo or a video dice game. If based in video, the wagering game machine 100 includes a video display 112 such as a cathode ray tube (CRT), liquid crystal display (LCD), plasma, or other type of video display known in the art. In the illustrated embodiment, the wagering game machine 100 is an “upright” version in which the display 112 is oriented vertically relative to a player. Alternatively, the wagering game machine may be a “slant-top” version in which the display 112 is slanted at about a thirty-degree angle toward the player. Further, the wagering game machine may be a “bar-top” version in which the display is mounted horizontally in a bar top or table top. Still further, the wagering game machine may housed in a wall mounted or other vertically mounted cabinet. Additionally, the wagering game machine may be a portable wagering game machine wherein the display, buttons and other user interface features may be omitted or scaled in size so that the fit in a housing meant to be easily carried by a user from place to place. For example, the housing may be approximately the size of a laptop, a hand-held computer or other similar portable device.

The wagering game machine 100 includes a plurality of possible credit receiving mechanisms 114 for receiving credits to be used for placing wagers in the game. The credit receiving mechanisms 114 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money.

In some embodiments, the wagering game machine 100 includes a user interface comprising a plurality of push-buttons 116, and other possible devices. The plurality of push-buttons 116 may, for example, include one or more “bet” buttons for wagering, a “play” button for commencing play, a “collect” button for cashing out, a help” button for viewing a help screen, a “pay table” button for viewing the pay table(s), and a “call attendant” button for calling an attendant. Additional game specific buttons may be provided to facilitate play of the specific game executed on the machine. A touch screen overlaying video display 112 may define touch keys for implementing many of the same functions as the push-buttons. Additionally, in the case of video poker, the touch screen may implement a card identification function to indicate which cards a player desires to keep for the next round. Other possible user interface devices include a keyboard and a pointing device such as a mouse or trackball.

In some embodiments, wagering game machine 100 includes a top box 140. Top box 140 may contain a video display, a mechanical display, or a diorama display that supplements display 112. For example, the display in top box 140 may be a wheel such as a rotating wheel, mechanical dice, a board for a board game, or other such display.

A processor controls operation of the wagering game machine 100. In response to receiving a wager and a command to initiate play, the processor randomly selects a game outcome from a plurality of possible outcomes and causes the display 112 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the CPU awards the player with a number of credits associated with the winning outcome.

In some embodiments, wagering game machine 100 may include signage 120. Signage 120 may be a display device capable of displaying advertising, gaming information (e.g. type of game, denomination of game etc.) or other information to a player or potential player.

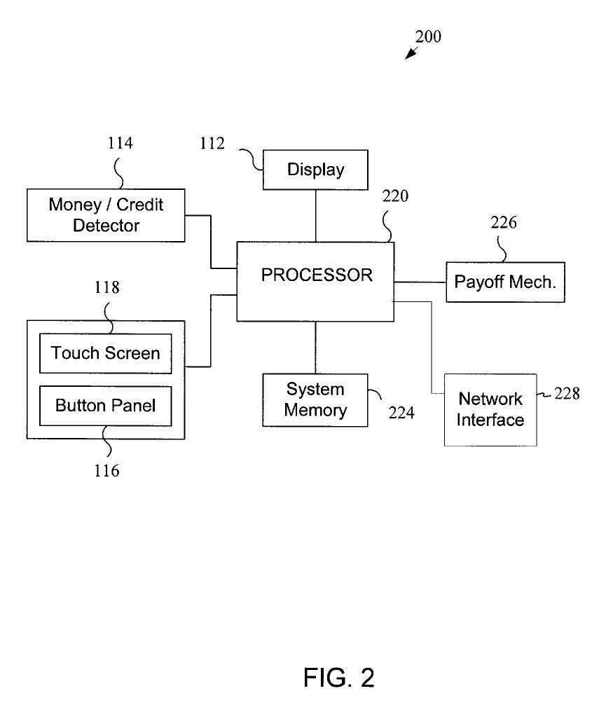

FIG. 2 is a block diagram of a control system 200 suitable for operating the wagering game machine 100. Money/credit detector 222 signals a processor 220 when a player has inserted money, tickets, tokens, cards or other mechanism for obtaining credits for plays on the wagering game machine through credit mechanisms 114. Using a button panel 116 and/or a touch screen 218, the player may select any variables associated with the wagering game and place his/her wager to purchase a play of the game. In a play of the game, the processor 220 generates at least one random event using a random number generator (RNG) and provides an award to the player for a winning outcome of the random event. Alternatively, the random event may be generated by a remote computer using an RNG or pooling schema and then transmitted to the wagering game machine. The processor 220 operates the display 112 to represent the random event(s) and outcome(s) in a visual form that can be understood by the player. In addition to the processor 20, the control system may include one or more additional slave control units for operating the display 112 and any secondary displays.

System memory 224 stores control software, operational instructions and data associated with the wagering game machine. In some embodiments, the system memory 224 comprises a separate read-only memory (ROM) and battery-backed random-access memory (RAM). However, it will be appreciated that the system memory 224 may be implemented on any of several alternative types of memory structures or may be implemented on a single memory structure. For example, memory 224 may comprise multiple banks of memory, including RAM, compact flash, hard drives, CD-ROM drives, DVD-ROM drives and combinations thereof.

A payoff mechanism 226 is operable in response to instructions from the processor 220 to award a payoff to the player. The payoff may, for example, be in the form of a number of credits. The number of credits is determined by one or more math tables stored in the system memory 224. As noted above with respect to FIG. 1, the payoff mechanism may be a coin hopper, a ticket printer, a magnetic card writer, or a database update mechanism that updates a database maintaining account information.

Network interface 228 operates to communicably couple system 200 in wagering game machine 100 to a network. The network may be any type of wired or wireless network and the network interface 228 may vary based on the type of network. In some embodiments, the network comprises a gaming establishment network such as a LAN (local area network). In alternative embodiments, the network may be an intranet linking multiple networks, for example, the networks of a gaming enterprise that operates multiple gaming establishments. In further alternative embodiments, the network may comprise the Internet.

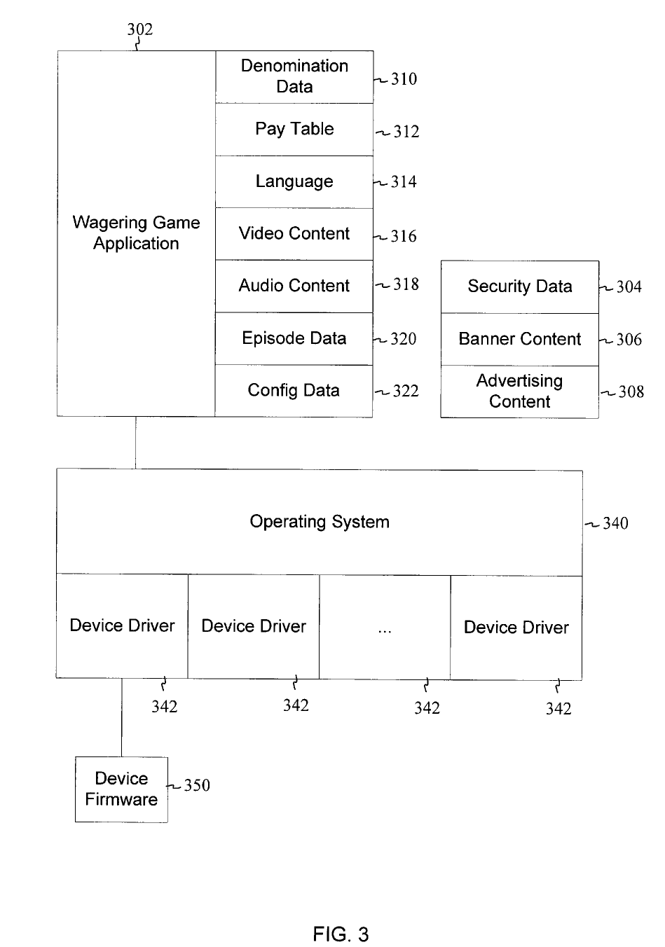

FIG. 3 illustrates various software executable and data components that may operate on a wagering game machine 100. These components may comprise configuration elements for the wagering game machine. In some embodiments, these components include wagering game application 302, game content and data 304-320, operating system 340, device driver 342 and device firmware 350.

Operating system 340 controls the execution of tasks, processes and applications (e.g. wagering game application 302) running on a wagering game machine, and provides interfaces between applications and the hardware present on a wagering game machine. The operating system may be proprietary to the wagering game machine manufacturer or owner, or the operating system may be provided by a third party. Examples of operating systems that may run within the wagering game machine environment include the Microsoft Windows family of operating systems, variants of the UNIX operating system, Linux, and real-time operating systems such as VRTX and QNX. The embodiments are not limited to any particular operating system.

Device driver 342 provides a software interface to hardware that may be present on a wagering game machine and software that desires to utilize such hardware, such as a wagering game application 302. Typically a device driver is a software component that is added to the operating system software, and must be designed to provide interfaces expected by the operating system. A different device driver 342 typically exists for each type of hardware present on a wagering game machine. For example, a ticket printer may have a device driver, a credit acceptor may have a different device driver etc.

Device firmware 350 comprises software that may be downloaded onto a persistent memory resident on a device that may be a component of wagering game machine 100. For example, a ticket printer may include an embedded processor that executes software or reads data from firmware on a flash memory resident on the ticket printer. Other devices that are part of wagering game machine 100 may also have firmware to control the operation and interface to the device.

Wagering game application 302 comprises software that controls the execution of a wagering game on wagering game machine 100. For example, the wagering game application may provide a slot machine application (video or mechanical), keno, card based wagering games (e.g. poker), dice based wagering games or other types of wagering games. The embodiments are not limited to a particular wagering game application.

Wagering game 302 may include one or more data or executable components. These components include denomination data 310, pay table 312, language data 314, video content 316, audio content 318, episode data 320, and configuration data 322. Denomination data 310 includes data that determines the denomination or denominations that the wagering game machine uses to determine the amount of a wager. For example, a wagering game machine may accept payment for credits in units of $0.25, $0.50, $1.00, $5.00 or other amounts. In addition, denomination data 310 also determines the currency for the wagered amount. For example, the currency may be United States dollars, French francs, Euros or other currency.

Pay table 312 may be used to determine which outcomes are winning outcomes and the amount to be credited or paid out for the various winning outcomes. Pay table 312 may be a single table in some embodiments. In alternative embodiments, multiple pay tables may be present on a wagering game machine and vary depending on which game or game version is currently in use.

Language data 314 comprises one ore more data sets or files that contain text to be displayed on the wagering game machine. The use of language data 314 allows a wagering game application to display text in the language common the location where the wagering game machine is used without requiring customization of the wagering game application.

Video content 316 comprises video data that may be displayed by wagering game application during the course of wagering game play or in an attract mode of the wagering game machine. For example, video content may comprise video clips that are displayed to the user during game play, during a bonus round, or while the wagering game machine is in attract mode.

Audio content 318 comprises audio data that may be played by the wagering game application during the course of wagering game play, bonus round play, or in an attract mode of the wagering game machine. In some embodiments, the audio content may be part of an audio program played on multiple wagering game machines to produce a surround-sound effect.

In some embodiments, a portion of video content 316 or audio content 318 may be provided by a gaming establishment and played during game play or in attract mode. This allows the gaming establishment to tailor a wagering game machine for their environment. For example, the gaming establishment may desire to provide video or audio content having a theme that is consistent with a theme within the gaming establishment as a whole.

Episode data 320 provides configuration data regarding episodes for a game. In some embodiments, the wagering game may be presented to the user in episodes. For example, bonus rounds may vary depending on the episode, or symbols and characters displayed during game play or game play rules may vary with each episode. Additionally, in some embodiments, some or all of video content 316 and audio content 318 may vary depending on the current episode. Episode data 320 may be used to determine which episode is currently presented to the user.

Configuration data 322 represents other types of configuration data related to the operation of a wagering game machine or a group of wagering game machines. Examples of such data include the uses for buttons present on the wagering game machine.

In addition to wagering game application related configuration elements, a wagering game machine may have other types of configuration components. In some embodiments, these components include security data 304, banner content 306 and advertising content 308. Security data 304 may be any type of security data related to the operation of a wagering game machine or group of wagering game machines. In some embodiments, the security data comprises user identification and/or password data. In alternative embodiments, the security data may comprise public key/private key encryption data. In further alternative embodiments, the security data may comprise key ring data for a group of keys. In still further embodiments, the security data may comprise biometric data. Additionally, the security data may comprise authentication and/or authorization data.

Banner content 306 comprises content intended to be displayed on a secondary display or overhead sign for a wagering game machine. The banner content may be displayed on a single wagering game machine, or it may be content designed to be displayed as part of the content for multiple wagering game machines. For example, the content may be displayed in a manner such that the content appears to travel from one machine to the next. Alternatively, the content may be one portion of a message that is displayed across multiple wagering game machines.

Advertising content 308 comprises advertising video, audio, or text data that may be played or displayed on a wagering game machine.

Various combinations of the above-described configuration elements may be downloaded onto a wagering game machine. It should be noted that no embodiment requires that all the above-described configuration elements be downloadable, rather varying embodiments will provide for the download of varying combinations of one or more of the above-described configuration elements.

Further, the above described configuration elements may be downloaded at different times. For example, it may be desirable to download wagering game applications components, operating system components, device driver components and the like when the machine is idle (i.e. not in use). However, other configuration elements such as episode data, banner content and advertising content may be downloaded at any time, including during wagering game play.

Additionally, some or all of the above-described configuration elements may have different versions. For example, the operating system 340, device driver 342, device firmware 350, or wagering game application 302 may exist in differing versions, with each version having differing combinations of features and/or updates to fix problems with previous versions. Typically a version will have a version identifier associated with it to indicate the software version for the configuration element.

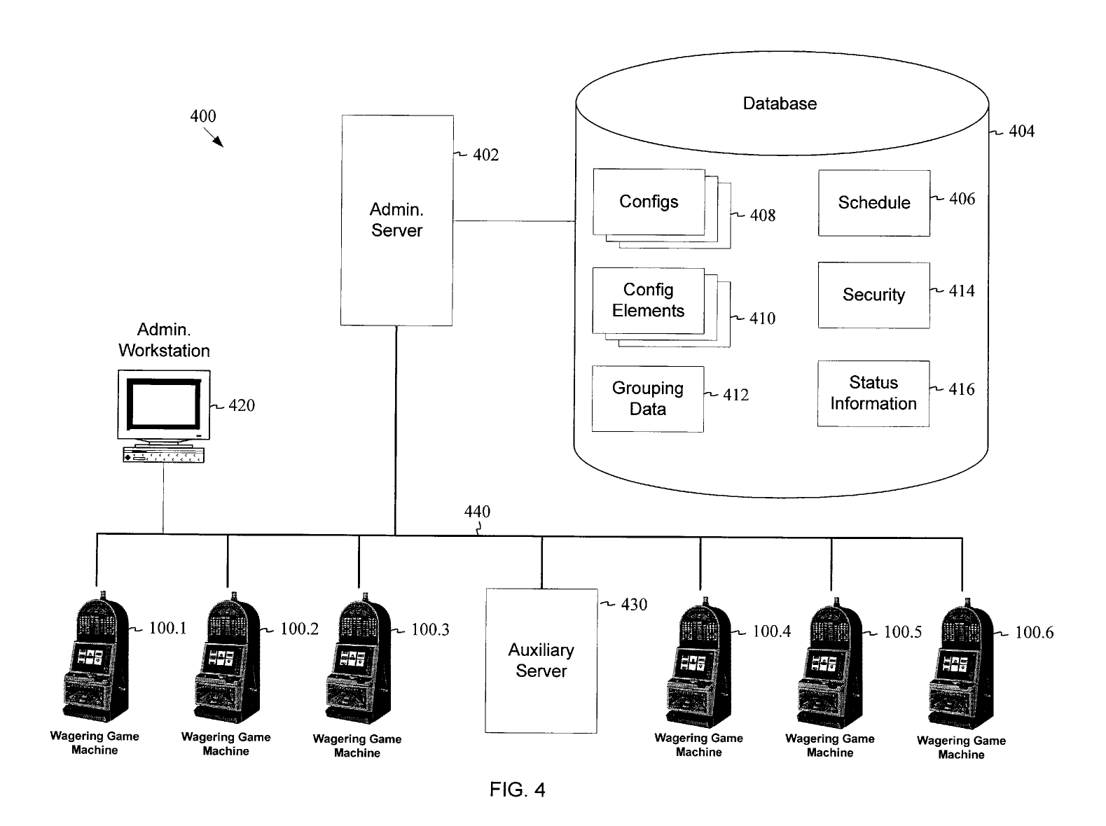

FIG. 4 illustrates various components of a wagering game machine network 400 in which embodiments of the invention may be incorporated. In some embodiments, the wagering game machine network include administrative server 402, administrative workstation 420 and wagering game machines 100, all communicably coupled via network 440. Network 440 may be a wired or wireless network, or a combination of wired and wireless networks. In some embodiments, network 440 is a gaming establishment local area network. In alternative embodiments, network 440 may be a network that links multiple gaming establishments or facilities. In further alternative embodiments, network 440 may include the Internet.

In some embodiments, administrative server 402 provides downloadable content to wagering game machines 100. The downloadable content may comprise any combination of the configuration elements described above with reference to FIG. 3. In some embodiments, content may be pushed from administrative server 402 to a wagering game machine. In alternative embodiments, wagering game machines 100 may pull content from administrative server 402.

In some embodiments, administrative server 402 maintains a database 404 of configurations and configuration elements available for download to wagering game machines 100. Although shown as one entity for convenience, database 404 may be comprised of multiple databases. Further, database 404 may be a relational database, hierarchical database, object oriented database, XML database or a set of one or more files in a file system and combinations of the above. In some embodiments, database 404 may include one or more configurations 408, configuration components 410, schedule 406, grouping data 412, security data 414 and status information 416.

A configuration 408 comprises data identifying the configuration components 410 that are to be loaded onto a wagering game machine, and may also include other parameters regarding the operation of a wagering game machine. The configuration components 410 may be data representing or identifying the configuration elements discussed above with respect to FIG. 3 or the configuration component may be the actual configuration element self. A particular configuration may be shared by multiple wagering game machines, that is, multiple wagering game machines may be identically configured so that they operate in an identical manner.

Schedule 406 comprises data regarding when a configuration 408 or configuration element represented by a configuration component 410 is to be downloaded to a wagering game machine in order to update the wagering game machine with one or more new configuration elements. The schedule 406 may specify a one time update at a particular time, or it may specify updates that are repeated at particular times of the day, days of the week, or days of the year. For example, denomination data may be updated at the same time of day each day of the week when demand for particular wagering games or wagering game machines is higher or lower. Thus a game that is $0.25 per credit during the early morning and daytime hours may be adjusted to a $1.00 per credit game during evening hours when demand may be higher.

Schedule 406 may also specify the earliest or latest time a wagering game machine is to be updated after the machine has become idle (i.e. not in use).

Grouping data 412 includes data that indicates how multiple wagering game machines may be associated with one another. The grouping data may specify machines that are part of a progressive wagering game. Additionally, the grouping data 412 may specify wagering game machines that are in proximity with one another and that are used to provide a surround sound effect, or to display banner content that appears to shift from wagering game machine to wagering game machine. Further, the grouping data may specify wagering game machines that are part of a “high rollers” set of wagering game machines intended for use by customers that engage in frequent wagering activity or tend to wager larger amounts.

Security data 414 represent authorization and authentication data used to verify who may access a wagering game machine and for what purposes. For example, technicians desiring to access a wagering game machine in order to diagnose or repair problems may be required to enter user identification and passwords. In addition, as mentioned above a public/private key combination may be used in which case security data 414 may include key or keyring information.

Status information 416 may include information regarding the current state of a wagering game machine. One example of such information includes the current versions of software loaded onto the machine. Such version information may be used to determine if an update is required. Additional status information may include the hardware present on the machine. This information may be useful to determine if software to be downloaded to a wagering game machine is compatible with the hardware present on the wagering game machine. Further status information may include whether the wagering game machine is currently in use, whether there has been a tilt condition detected on the wagering game machine and other runtime information regarding the wagering game machines current status.

Administrative workstation 420 in some embodiments provides a user interface to casino personnel that may be used to configure, control and update wagering game machines on a wagering game machine network 440. Traditionally, to change gaming content, denominations, paytable (lines, percentages) or languages a technician would have to go to a casino, find the wagering game machine on the floor and perform a RAM Clear and reconfigure in the case of denominations and paytable. For languages, a casino technician would have to find the wagering game machine on the casino floor and physically enter the Operator Menu and change the languages.

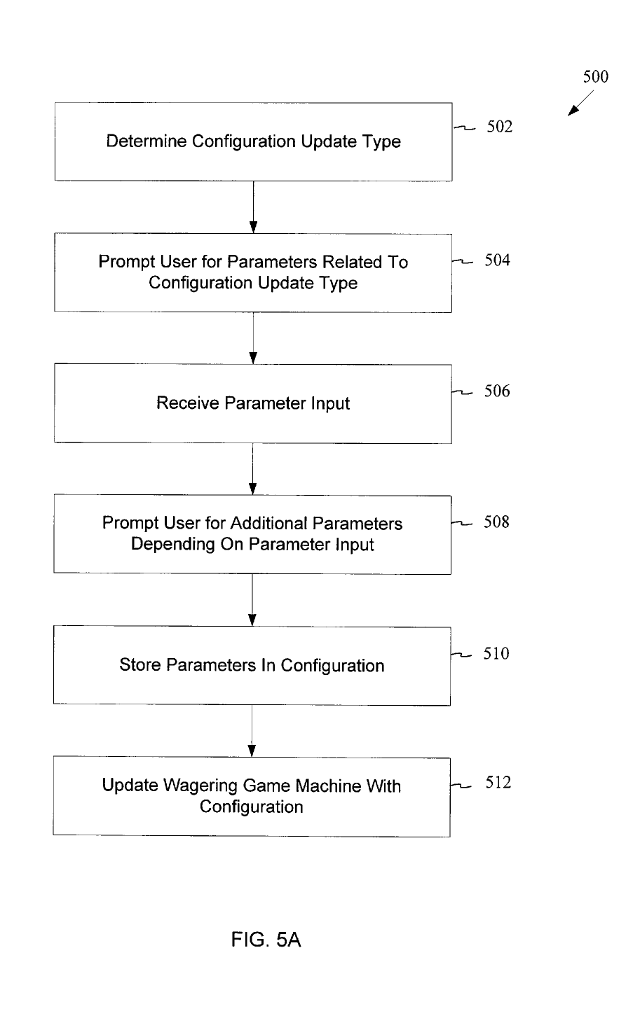

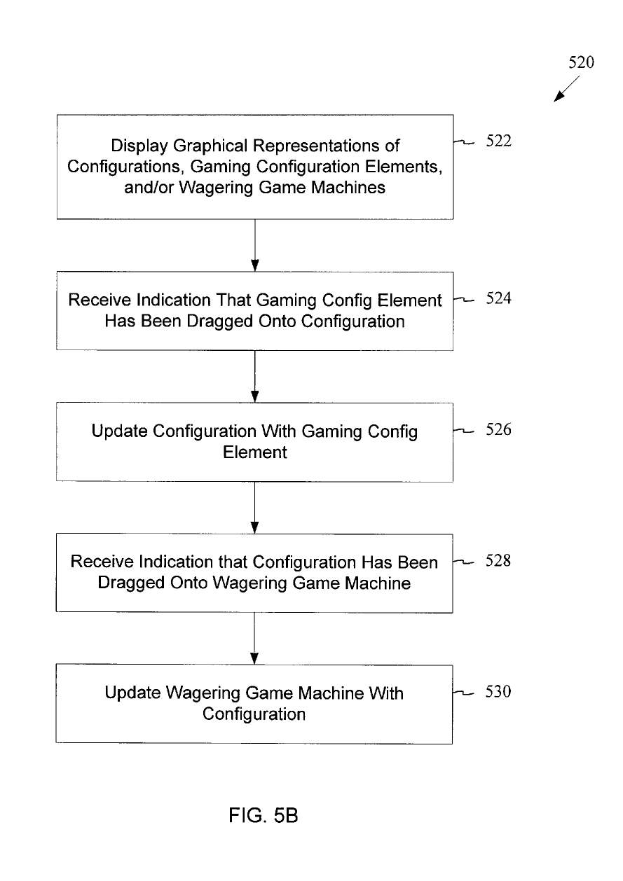

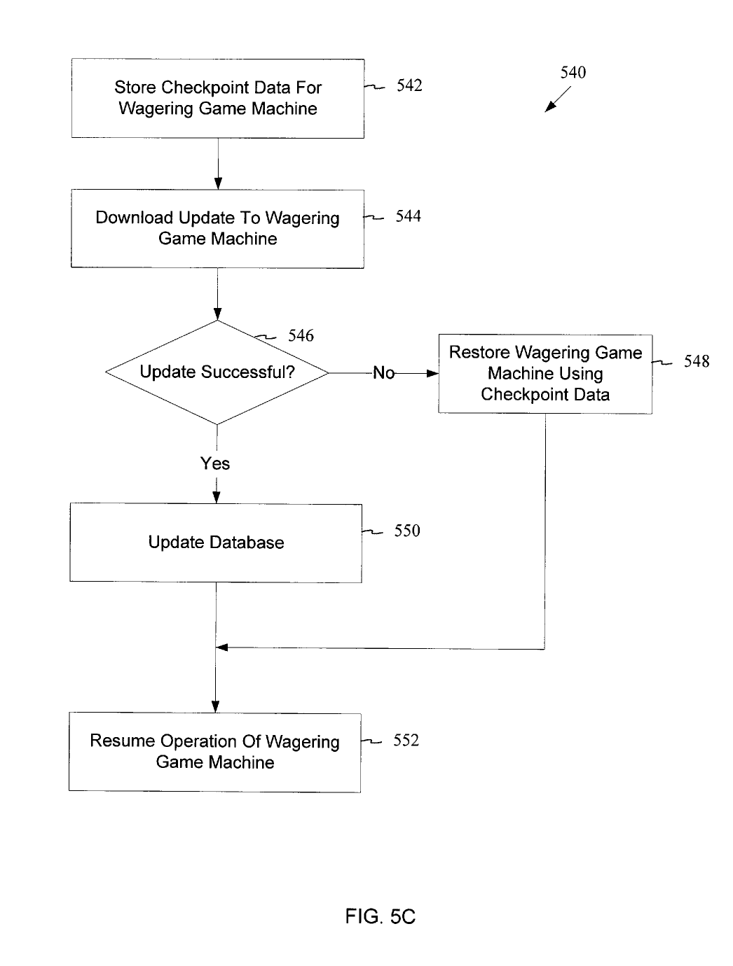

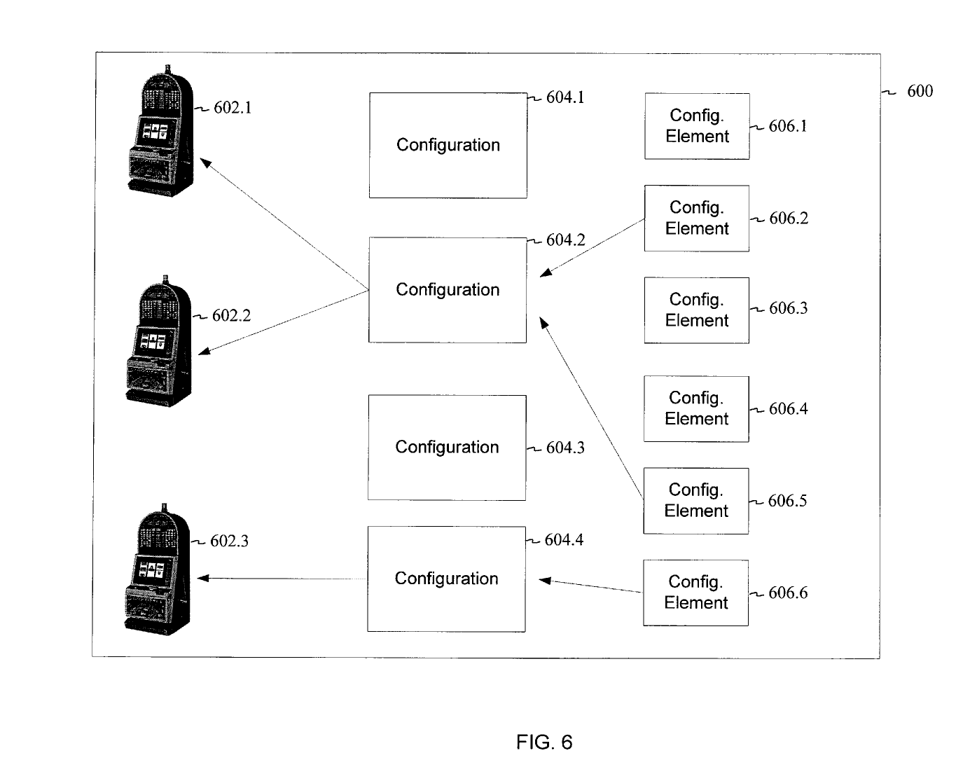

In one embodiment, the administrative workstation provides an interface that allows the casino technician to perform various desired functions, such as changing language configuration, changing paytables lines, percentages and denominations, changing theme, and updating casino specific content. In some embodiments, the interface may comprise a “wizard” interface that assists the technician in configuring one or more wagering game machines by prompting the technician for relevant parameters. In alternative embodiments a “drag and drop” interface may be provided on the administrative workstation 420. Further details on these interfaces are provided below with reference to FIGS. 5A, 5B and 6.

In addition to manually changing these attributes, the casino operator may also use the administrative workstation 420 to edit schedule changes for wagering game machine configuration elements by day, time of day and/or month, allowing casino operators to maximize payout for peak casino playing times and to personalize content for a gaming establishment. The schedule may also provide for theme changes during holiday periods or seasons of the year.

Language configurations may also be changed using the administrative workstation 420. When casino operators want to change languages, the administrative workstation may be used to select one or more of the available languages and use the interface to enable or download the languages listed. The wagering game machine then updates the languages available to the player from a selected device on the gaming network.

Denominations and pay tables (lines/percentages) may also be configured and/or updated using the administrative workstation 420. In some embodiments, the pay table and denominations that a wagering game machine can support may be stored in status information in the database. A casino operator may use the administrative workstation 420 to change desired denominations and/or paytable. The wagering game machine is then updated with new denomination and/or pay table data. The wagering game machine then changes to the appropriate denomination and/or pay table.

Administrative workstation 420 may also control and reset a wagering game machine remotely. For example, a “RAM clear” may be required to be performed in order to insure that memory is cleared before certain updates may be applied (e.g. pay table, denomination updates). The administrative workstation may issue a RAM clear to a wagering game machine prior to updating the machine by selecting a graphical representation of the wagering game machine from the user interface and then selecting an appropriate icon or menu item to issue the command.

Additionally, wagering game machines may be placed in a “tilt” condition in which the wagering game machine is frozen from further use when the machine senses unusual movement due to being bumped, shaken or struck by a wagering game user. In some embodiments, a graphical element representing the wagering game machine in the tilt condition is highlighted on a graphical user interface on the administrative workstation. A “clear tilt” command is required in order to cause the wagering game machine to resume operation. In some embodiments, the “clear tilt” command may be provided remotely from the administrative workstation 420. A wagering game machine in a tilt condition may be highlighted on a user interface on the administrative workstation. A clear tilt command may be issued by selecting the graphical representation of the wagering game machine from the user interface and then selecting an appropriate icon or menu item to issue the command.

In one embodiment, the administrative workstation 420 may enable an audio connection with the wagering game machine in order to communicate with the wagering game machine user. The communication line may be also used to communicate with a technician repairing or diagnosing the wagering game machine.

In some embodiments, system 400 includes an auxiliary server 430. Auxiliary server 430 may be any type of server coupled to network 440 that provides gaming related services. For example, Auxiliary server 430 may be a progressive server that manages a progressive wagering game in which multiple wagering game machines contribute to a pool of potential winnings that may be paid out to any wagering game machine participating in the progressive wagering game upon certain outcomes. Alternatively, auxiliary server 430 may be an overhead sign controller that controls the display of overhead signs in a gaming establishment. Other types of auxiliary servers are within the scope of the inventive subject matter. In some embodiments, administrative workstation 420 may be used to configure and control these auxiliary servers in the same manner as described above for wagering game machines.

These features, combined with the ability to configure and update all of them by time of day, gives much greater flexibility to casino operators in how they use products having the ability to obtain updated information from other device on the network. It also makes updating them much faster and requires less support by manufacturers. It would also allow casinos to maximize their profits by automatically adjusting payout based on usage rates and theme popularity.

FIGS. 5A-5C are flowcharts illustrating methods for administering a system of wagering game machines according to various embodiments of the invention. The methods to be performed by the operating environment constitute computer programs made up of computer-executable instructions. Describing the methods by reference to a flowchart enables one skilled in the art to develop such programs including such instructions to carry out the method on suitable processors for wagering game machines (the processor or processors of the computer executing the instructions from computer-readable media). The methods illustrated in FIGS. 5A-5C are inclusive of acts that may be taken by an operating environment executing an exemplary embodiment of the invention.

FIG. 5A illustrates a method 500 for defining a configuration for one or more wagering game machines according to various embodiments of the invention. The method begins by determining a configuration update type (block 502). In some embodiments, a configuration update type may be determined from a menu selection. In alternative embodiments, a configuration update type may be determined by an icon selection. In further alternative embodiments, a configuration update type may be determined by selecting a graphical representation of a configuration element from the user interface. Those of skill in the art will appreciate that other methods for determining a configuration type exist and are within the scope of the inventive subject matter.

Next, the system prompts the user to enter one or more parameters related to the configuration type (block 504). For example, if a new version of software is to be made part of the configuration, the user may be prompted to enter the location of the file containing the new version. Alternatively, the user may be prompted to enter a version identifier. Various user interface mechanisms may be used to aid in making sure valid data is entered. For example, in cases where only a predetermined number of values is valid, those valid values may be listed in a drop-down box or provided with check boxes to indicate selection. The system then receives the parameter input from the user via the user interface (block 506).

At block 508, the user may be prompted to enter additional or varying parameters based on the input data supplied at block 406. For example, if a user provides parameter input indicating that particular optional features are to be enabled in the configuration, then the system may provide prompts for the user to input additional parameters related to the optional features.

Blocks 504-508 may be repeated as desired until a valid configuration is obtained.

The system then stores the input parameters as part of a configuration (block 510). The configuration may then be used to update one or more wagering game machines in a network of wagering game machines (block 512).

FIG. 5B illustrates a method 520 for defining a configuration for one or more wagering game machines according to various embodiments of the invention. The method begins by displaying graphical representations of configurations, gaming configuration elements, and/or wagering game machines (block 522). The graphical representations may be icons that resemble the actual physical entity or data that they represent. For example, a wagering game machine icon may represent a particular wagering game machine, a file or folder icon may represent a configuration, and an icon representing a symbol used in a game may represent a wagering game application.

Next, the system receives an indication that one of the graphical representations of a gaming configuration element has been dragged over a graphical representation of a configuration (block 524). The system then causes the configuration to be updated with the gaming configuration element (block 526). In some embodiments, the user may be prompted to enter additional parameters that may be used in the configuration. In some embodiments, the additional parameters may be obtained using the method described above with reference to FIG. 5A. Additionally, in some embodiments, the user may be asked if the configuration update should be scheduled for a later time.

In addition, wagering game machines may have configuration elements downloaded to them using a graphical user interface. In some embodiments, a graphical representation of a configuration may be dragged onto a graphical representation for a particular wagering game machine (block 528).

The wagering game machine is then updated with the configuration by downloading the configuration elements in the configuration to the wagering game machine (block 530). In some embodiments, all of the configuration elements may in the configuration may be downloaded to the wagering game machine. In alternative embodiments, the system determines which configuration elements have changed since a previous download. The system then downloads those configuration elements that have changed to the wagering game machine.

It should be noted that in some embodiments, configuration elements may be downloaded (or scheduled for download) by dragging a graphical representation of the configuration element directly over a graphical representation of a particular wagering game machine, thereby bypassing adding the configuration element to a configuration. In some embodiments, dragging a configuration element over a wagering game machine automatically adds the configuration element to the current configuration associated with the wagering game machine in addition to downloading the configuration element.

FIG. 5C provides further details on a method 540 for updating a wagering game machine according to various embodiments of the invention. In some embodiments, prior to downloading a new configuration element or elements, the system stores checkpoint data for the wagering game machine (block 542). The checkpoint data may be stored on the wagering game machine itself or on some other machine or server in the gaming network.

Next, the configuration element or elements are downloaded to the wagering game machine (block 544). A check is then made to determine if the update was successful (block 546). In some embodiments, the check may consist of an observation by a technician as to whether or not the wagering game machine operated normally following the download. In alternative embodiments, the check may be automated, by receiving an indication over the network that the downloaded configuration elements were received correctly and are operating.

If the check at block 546 indicates that the update was successful, in some embodiments a database such as database 404 may be updated to indicate new versions of configuration elements were successfully downloaded to the wagering game machine (block 550). The wagering game machine then resumes operation (block 552).

If the check at block 546 indicates that the update was not successful, then the wagering game machine may be restored to its prior state using the checkpoint data (block 548). The wagering game machine then resumes operation (block 552)

FIG. 6 provides an example graphical user interface 600 illustrating one aspect of the configuration methods described above. In the example interface, various graphical representations for gaming related items are displayed on a screen or window. For example, in some embodiments, graphical representations of wagering game machines 602, configurations 604, and configuration elements 606 may be displayed. As noted above, the graphical representations may be suggestive of the underlying item, e.g. a wagering game machine icon may be used to represent a particular physical wagering game machine, a dollar sign icon may be used to represent a denomination configuration element, etc. In the example shown, graphical representations of configuration elements 606.2 and 606.5 are dragged over the graphical representation of configuration 604.2. The configuration is then update with the corresponding configuration element. Similarly, a graphical representation of configuration element 606.6 may be dragged over a graphical representation of configuration 604.4, causing the configuration to be updated.

Then, in the example shown, the graphical representation of configuration 604.2 is dragged to two graphical representations of wagering game machines 602.1 and 602.2. This causes the configuration elements in the configuration to be downloaded to the corresponding wagering game machines.

Similarly, dragging the graphical representation of configuration 604.4 over the graphical representation of wagering game machine 602.3 causes the configuration elements in the associated configuration to be downloaded the associated wagering game machine.

As can be seen from the above, the administrative interfaces provided by the embodiments of the invention allow a user to conveniently update one or more wagering game machines in a graphical and intuitive manner. In addition, multiple wagering game machines that should have the same configuration may be easily updated using the graphical interface described above.

### CONCLUSION

Systems and methods for providing an administrative interface to manage a network of wagering game machines have been described. Although specific embodiments have been illustrated and described herein, it will be appreciated by those of ordinary skill in the art that any arrangement which is calculated to achieve the same purpose may be substituted for the specific embodiments shown. For example, the configuration and download methods described above were provided in the context of updating one or more wagering game machines. The systems and method may also be used to update configuration elements on other devices on a gaming network. For example, auxiliary servers such as progressive servers, overhead sign controllers and other devices may be administered in the same manner as described above. This application is intended to cover any adaptations or variations of the inventive subject matter.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A method for administering a network of wagering game machines, the method comprising:
providing one or more wagering game machines, the one or more wagering game machines operable to present a wagering game;
displaying a graphical representation of at least one gaming configuration element and a graphical representation of at least one configuration;
receiving an indication that the graphical representation of the gaming configuration element has been dragged over the graphical representation of the configuration; and
updating the configuration with the gaming configuration element.

2. The method of claim 1, further comprising:
displaying a graphical representation of at least one wagering game machine of the one or more wagering game machines;
receiving an indication that the graphical representation of the configuration has been dragged over the graphical representation of the wagering game machine; and
updating the wagering game machine with the configuration.

3. The method of claim 2, wherein updating the wagering game machine includes scheduling the update for a later time.

4. The method of claim 3, wherein the later time includes a particular time of day.

5. The method of claim 3, wherein the later time comprises a time when the wagering game machine is idle.

6. The method of claim 2, further comprising storing a set of checkpoint data for the wagering game machine prior to updating the wagering game machine with the configuration.

7. The method of claim 6, further comprising restoring the wagering game machine configuration utilizing the set of checkpoint data.

8. The method of claim 1, wherein the gaming configuration element includes an element selected from the group consisting of banner content, advertising content, denomination, pay table, language data, video content, audio content, episodic game data, wagering game software, operating system software, device driver software, and device firmware.

9. A method for configuring a wagering game machine, the method comprising:
determining a configuration update type;
displaying a prompt for a first set of one or more parameters associated with the configuration update type;
receiving a set of input for the first set of one or more parameters; and
storing the set of input in a configuration data set.

10. The method of claim 9, further comprising:
displaying a prompt for a second set of one or more parameters, the second set of one or more parameter depending on a parameter value for the first set of one or more parameters; and

11. A method for administering a wagering game machine, the method comprising:
receiving by an administrative workstation an indication of a change in wagering game machine condition; and
issuing a command from the remote system to the wagering game machine to reset the wagering game machine condition.

12. The method of claim 1 1, wherein the indication of a change in wagering game machine condition includes highlighting a graphical representation of the wagering game machine on a user interface.

13. The method of claim 11, wherein the wagering game machine condition comprises a tilt condition.

14. The method of claim 11, further comprising enabling an audio communication line between the administrative workstation and the wagering game machine.

15. A gaming administration system comprising:
an administration server communicably coupled to a network;
a database coupled to the administration server, the database maintaining configuration data and gaming configuration element data;
an administrative workstation communicably coupled to the network and operable to provide a user interface for manipulating the gaming configuration element data and the configuration data to configure one or more wagering game machines communicably coupled to the network.

16. The gaming administration system of claim 15, wherein the user interface is operable to:
display a graphical representation of at least one gaming configuration element and a graphical representations of at least one configuration;
receive an indication that the graphical representation of the gaming configuration element has been dragged over the graphical representation of the configuration; and
update the configuration with the gaming configuration element.

17. The gaming administration system of claim 15, wherein the user interface is operable to:
determine a configuration update type;
display a prompt for a first set of one or more parameters associated with the configuration update type;
receive a set of input for the first set of one or more parameters; and
store the set of input in a configuration.

18. The gaming administration system of claim 15, further comprising a schedule specifying a time for updating one or more wagering game machines.

19. The gaming administration system of claim 15, wherein the administration workstation is further operable to cause a download of a gaming configuration element to at least one wagering game machine.

20. The gaming administration system of claim 19, wherein the gaming configuration element includes an element selected from the group consisting of banner content, advertising content, denomination, pay table, language data, video content, audio content, episodic game data, wagering game software, operating system software, device driver software, and device firmware.

21. A computer-readable medium having computer executable instructions for performing a method for administering a network of wagering game machines, the method comprising:
displaying a graphical representation of at least one gaming configuration element and a graphical representation of at least one configuration;
receiving an indication that the graphical representation of the gaming configuration element has been dragged over the graphical representation of the configuration; and
updating the configuration with the gaming configuration element.

22. The computer-readable medium of claim 21, wherein the method further comprises:
displaying a graphical representation of at least one wagering game machine;
receiving an indication that the graphical representation of the configuration has been dragged over the graphical representation of the wagering game machine; and
updating the wagering game machine with the configuration.
